(19) United States
(12) Patent Application Publication
(10) Pub. No.: US 2021/0149035 A1
(43) Pub. Date: May 20, 2021

(54) RADAR DEVICE AND TARGET ANGLE MEASUREMENT METHOD

(71) Applicant: Mitsubishi Electric Corporation, Tokyo (JP)

(72) Inventor: Toshihiro ITO, Tokyo (JP)

(73) Assignee: Mitsubishi Electric Corporation, Tokyo (JP)

(21) Appl. No.: 17/159,571

(22) Filed: Jan. 27, 2021

Related U.S. Application Data
(63) Continuation of application No. PCT/JP2018/031795, filed on Aug. 28, 2018.

(51) Int. Cl. G01S 13/04; G01S 7/28; G01S 13/42; H01Q 3/26; H01Q 25/02

(52) U.S. Cl. CPC G01S 13/04; G01S 7/2813; G01S 2013/0254; H01Q 3/2611; H01Q 25/02; G01S 13/426

(57) ABSTRACT

Multiple subarray antennas each having multiple element antennas, multiple sum signal generation units respectively connected to the multiple subarray antennas, for each generating a sum signal of signals of the multiple element antennas which each of the subarray antennas has; multiple difference signal generation units respectively connected to the multiple subarray antennas, for each generating a difference signal of the signals of the multiple element antennas which each of the subarray antennas has; and an angle measurement unit for performing a beamformer angle measurement on a target by using the sum signals generated by the multiple sum signal generation units and the difference signals generated by the multiple difference signal generation units are included.

### CROSS REFERENCE TO RELATED APPLICATIONS

This application is a Continuation of PCT International Application No. PCT/JP2018/031795, filed on Aug. 28, 2018, which is hereby expressly incorporated by reference into the present application.

### TECHNICAL FIELD

The present disclosure relates to a radar device for and a target angle measurement method of performing an angle measurement on a target.

### BACKGROUND ART

In Nonpatent Literature 1 below, a radar device having a distributed array antenna in which multiple subarray antennas are distributed is disclosed as a radar device that performs an angle measurement on a target.

The radar device disclosed in Nonpatent Literature 1 performs a digital beam forming (DBF) process, to generate multiple beams, and detects a target from the multiple beams.

Then, the radar device disclosed in Nonpatent Literature 1 performs an angle measurement in both an elevation angle direction and an azimuth angle direction in which the detected target is present.

### CITATION LIST

### Nonpatent Literature

Nonpatent Literature 1: “Distributed Array Radar”, R.C. HEIMILLER, J.E. BELYEA, P.G. TOMLINSON

### SUMMARY OF INVENTION

### Technical Problem

In the radar device disclosed in Nonpatent Literature 1, there is a case in which the number of element antennas which some of the subarray antennas of the multiple subarray antennas have is small depending on constraints such as locations at which the multiple subarray antennas are arranged.

In the case in which the number of element antennas which some of the subarray antennas have is small, one or more grating lobes (hereinafter referred to as “GL”) may occur in the antenna pattern.

A problem is that when GLs occur in the antenna pattern, errors of an angle measurement value of a target are larger than those when no GLs occur in the antenna pattern.

The present disclosure is made in order to solve the above-mentioned problem, and it is therefore an object of the present disclosure to obtain a radar device and a target angle measurement method capable of suppressing the expansion of errors of an angle measurement value even when one or more GLs occur in the antenna pattern.

### Solution to Problem

A radar device according to the present disclosure includes: multiple subarray antennas each having multiple element antennas; multiple sum signal generators respectively connected to the multiple subarray antennas, for each generating a sum signal of signals of the multiple element antennas which each of the subarray antennas has; multiple difference signal generators respectively connected to the multiple subarray antennas, for each generating a difference signal of the signals of the multiple element antennas which each of the subarray antennas has; and processing circuitry to perform a beamformer angle measurement on a target by searching for one or more angles of the target using the sum signals generated by the multiple sum signal generators and the difference signals generated by the multiple difference signal generators.

### Advantageous Effects of Invention

According to the present disclosure, the radar device is configured in such a way as to include the angle measurement unit for performing a beamformer angle measurement on a target by using the sum signals generated by the multiple sum signal generation units and the difference signals generated by the multiple difference signal generation units. Therefore, the radar device according to the present disclosure can suppress the expansion of errors of an angle measurement value even when one or more GLs occur in the antenna pattern.

### BRIEF DESCRIPTION OF DRAWINGS

FIG. 1 is a block diagram showing a radar device according to Embodiment 1;

FIG. 2 is a hardware block diagram showing the hardware of a signal processing device 10 of the radar device shown in FIG. 1;

FIG. 3 is a hardware block diagram of a computer in the case in which the signal processing device 10 is implemented by software, firmware, or the like;

FIG. 4 is a flowchart showing a part of a target angle measurement method that is a processing procedure in the case in which the signal processing device 10 is implemented by software, firmware, or the like;

FIG. 5 is an explanatory drawing showing a result of comparison between a beamformer angle measurement using only sum signals, and a monopulse angle measurement in a subarray aperture;

FIG. 6 is an explanatory drawing showing the distribution of errors of an angle measurement value in the beamformer angle measurement using only sum signals, the distribution of errors of an angle measurement value in the monopulse angle measurement, and the distribution of errors of an angle measurement value in a beamformer angle measurement by an angle measurement unit 14;

FIG. 7 is a block diagram showing another radar device according to Embodiment 1;

FIG. 8 is a block diagram showing another radar device according to Embodiment 1;

FIG. 9 is a block diagram showing an angle measurement unit 14 of a radar device according to Embodiment 2;

FIG. 10 is a block diagram showing a radar device according to Embodiment 3;

FIG. 11 is a block diagram showing a radar device according to Embodiment 4; and

FIG. 12 is a block diagram showing a radar device according to Embodiment 5.

### DESCRIPTION OF EMBODIMENTS

Hereinafter, in order to explain the present disclosure in greater detail, embodiments of the present disclosure will be described with reference to the accompanying drawings.

### Embodiment 1

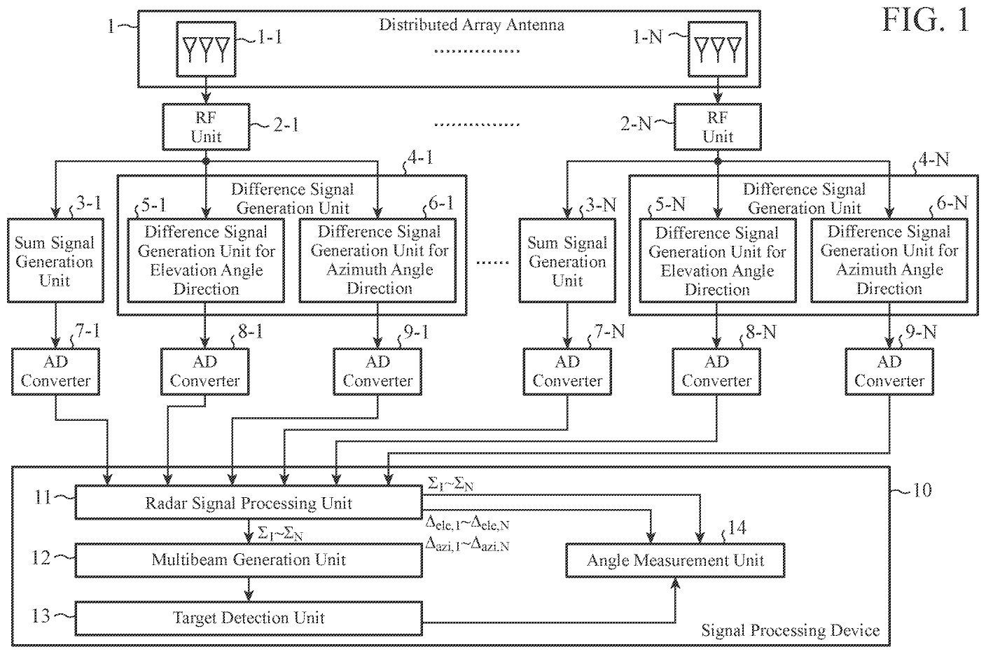

FIG. 1 is a block diagram showing a radar device according to Embodiment 1.

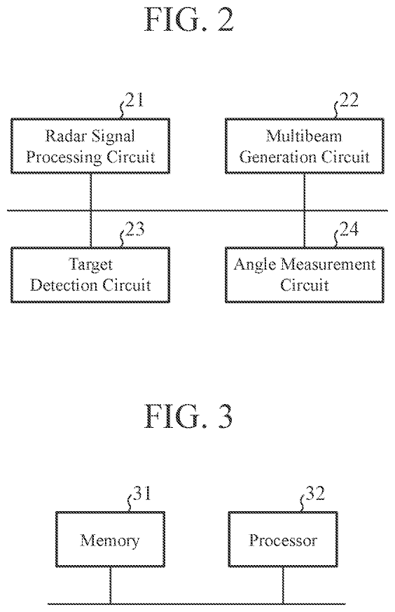

FIG. 2 is a hardware block diagram showing the hardware of a signal processing device 10 of the radar device shown in FIG. 1.

Although the radar device shown in FIG. 1 can perform both a process of transmitting an electric wave and a process of receiving an electric wave, because the radar device is characterized by the process of receiving an electric wave, a configuration for performing the process of receiving an electric wave is disclosed. Because a configuration for performing the process of transmitting an electric wave is the same as that of a typical radar device, description about this configuration is omitted in FIG. 1.

In FIGS. 1 and 2, a distributed array antenna 1 is one in which multiple subarray antennas 1-1 to 1-N are distributed. N is an integer equal to or greater than 2.

The subarray antenna 1-n (n=1, . . . , N) has multiple element antennas.

The intervals at which the multiple subarray antennas 1-1 to 1-N are arranged may be equal or unequal. In the case in which the intervals at which the multiple subarray antennas 1-1 to 1-N are arranged are unequal, the influence of GLs can be reduced.

In the radar device shown in FIG. 1, the multiple subarray antennas 1-1 to 1-N are arranged one-dimensionally. However, no limitation is intended to this arrangement, and the multiple subarray antennas 1-1 to 1-N may be arranged two-dimensionally.

Radio frequency (RF) units 2-1 to 2-N are connected respectively to the subarray antennas 1-1 to 1-N.

The RF unit 2-n detects each of received signals of the multiple element antennas which the subarray antenna 1-n has, and performs amplification and so on on each of the received signals detected.

The RF unit 2-n outputs each of the received signals on which the RF unit has performed amplification and so on to both a sum signal generation unit 3-n and a difference signal generation unit 4-n.

Sum signal generation units 3-1 to 3-N are connected respectively to the RF units 2-1 to 2-N, and are implemented by, for example, adders or combiners.

The sum signal generation unit 3-n generates a sum signal Σ about the received signals of the multiple element antennas, the received signals being outputted from the RF unit 2-n.

For example, the sum signal generation unit 3-n generates the sum signal Σₙ by combining the received signals of the multiple element antennas, the received signals being outputted from the RF unit 2-n, in such a way that the received signals of the multiple element antennas are in phase with respect to a subarray beam direction which will be mentioned later.

The sum signal generation unit 3-n outputs the generated sum signal Σₙ to an analog to digital converter (referred to as an “AD converter” hereafter) 7-n.

Difference signal generation units 4-1 to 4-N are connected respectively to the RF units 2-1 to 2-N.

The difference signal generation unit 4-n includes a difference signal generation unit for elevation angle direction 5-n and a difference signal generation unit for azimuth angle direction 6-n.

The difference signal generation unit 4-n generates difference signals about the received signals of the multiple element antennas, the received signals being outputted from the RF unit 2-n.

Difference signal generation units for elevation angle direction 5-1 to 5-N are connected respectively to the RF units 2-1 to 2-N, and are implemented by, for example, adders or combiners, and difference units.

The difference signal generation unit for elevation angle direction 5-n divides the aperture of the subarray antenna 1-n into two parts in an elevation angle direction.

The difference signal generation unit for elevation angle direction 5-n generates a first sum signal Σ_{ele,1,n} by combining the received signals of the multiple element antennas for one of the two parts into which the aperture is divided in such a way that the received signals of the multiple element antennas for the one of the two parts of the aperture are in phase in the subarray beam direction.

The difference signal generation unit for elevation angle direction 5-n generates a second sum signal Σ_{ele,2,n} by combining the received signals of the multiple element antennas for the other one of the two parts into which the aperture is divided in such a way that the received signals of the multiple element antennas for the other one of the two parts of the aperture are in phase in the subarray beam direction.

The difference signal generation unit for elevation angle direction 5-n calculates the difference between the first sum signal Σ_{ele,1,n} and the second sum signal Σ_{ele,2,n} as a difference signal Δ_{ele,n}, and outputs the difference signal Δ_{ele,n} to an AD converter 8-n.

Difference signal generation units for azimuth angle direction 6-1 to 6-N are connected respectively to the RF units 2-1 to 2-N, and are implemented by, for example, adders or combiners, and difference units.

The difference signal generation unit for azimuth angle direction 6-n divides the aperture of the subarray antenna 1-n into two parts in an azimuth angle direction.

The difference signal generation unit for azimuth angle direction 6-n generates a first sum signal Σ_{azi,1,n} by combining the received signals of the multiple element antennas corresponding to one of the two parts into which the aperture is divided in such a way that the received signals of the multiple element antennas corresponding to the one of the two parts of the aperture are in phase in the subarray beam direction.

The difference signal generation unit for azimuth angle direction 6-n generates a second sum signal Σ_{azi,2,n} by combining the received signals of the multiple element antennas corresponding to the other one of the two parts into which the aperture is divided in such a way that the received signals of the multiple element antennas corresponding to the other one of the two parts of the aperture are in phase in the subarray beam direction.

The difference signal generation unit for azimuth angle direction 6-n calculates the difference between the first sum signal Σ_{azi,1,n} and the second sum signal Σ_{azi,2,n} as a difference signal Δ_{azi,n}, and outputs the difference signal Δ_{azi,n} to an AD converter 9-n.

AD converters 7-1 to 7-N are connected respectively to the sum signal generation units 3-1 to 3-N.

The AD converter 7-n converts the sum signal Σₙ generated by the sum signal generation unit 3-n from analog signal into digital signal.

The AD converter 7-n outputs the digital signal as digital sum signal Σₙ to the signal processing device 10.

Here, for the sake of simplicity, the analog sum signal generated by the sum signal generation unit 3-n and the digital sum signal outputted from the AD converter 7-n are denoted by the same symbol “Σₙ.”

AD converters 8-1 to 8-N are connected respectively to the difference signal generation unit for elevation angle directions 5-1 to 5-N.

The AD converter 8-n converts the difference signal Δ_{ele,n} generated by the difference signal generation unit for elevation angle direction 5-n from analog signal into digital signal.

The AD converter 8-n outputs the digital signal as digital difference signal Δ_{ele,n} to the signal processing device 10.

Here, for the sake of simplicity, the analog difference signal generated by the difference signal generation unit for elevation angle direction 5-n and the digital difference signal outputted from the AD converter 8-n are denoted by the same symbol “Δ_{ele,n}.”

AD converters 9-1 to 9-N are connected respectively to the difference signal generation unit for azimuth angle directions 6-1 to 6-N.

The AD converter 9-n converts the difference signal Δ_{azi,n} generated by the difference signal generation unit for azimuth angle direction 6-n from analog signal into digital signal.

The AD converter 9-n outputs the digital signal as digital difference signal Δ_{azi,n} to the signal processing device 10.

Here, for the sake of simplicity, the analog difference signal generated by the difference signal generation unit for azimuth angle direction 6-n and the digital difference signal outputted from the AD converter 9-n are denoted by the same symbol “Δ_{azi,n}.”

The signal processing device 10 includes a radar signal processing unit 11, a multibeam generation unit 12, a target detection unit 13, and an angle measurement unit 14.

The radar signal processing unit 11 is implemented by, for example, a radar signal processing circuit 21 shown in FIG. 2.

The radar signal processing unit 11 receives the digital sum signals Σ₁ to Σₙ outputted from the AD converters 7-1 to 7-N, the digital difference signals Σ_{ele,1} to Δ_{ele,N} outputted from the AD converters 8-1 to 8-N, and the digital difference signals Δ_{azi,1} to Δ_{azi,N} output ted from the AD converters 9-1 to 9-N.

The radar signal processing unit 11 performs various types of signal processing on the digital sum signals Σ₁ to Σₙ, the digital difference signals Δ_{ele,1} to Δ_{ele,N} and the digital difference signals Δ_{azi,1} to Δ_{azi,N}.

As the various types of signal processing, for example, well-known processes shown hereafter can be considered, and the radar signal processing unit 11 performs one or more of the following processes.

Decimation process for reducing the processing load

Pulse compression process for improving the gain of a target signal

Inter-hit integrating process for improving the gain of a target signal

Moving target indicator (MTI) process for suppressing clutters

Side lobe clutter (SLC) process for suppressing interference waves

Here, for the sake of simplicity, the digital sum signal outputted from the AD converter 7-n and the digital sum signal after the signal processing by the radar signal processing unit 11 are denoted by the same symbol “Σₙ.”

Furthermore, the digital difference signal outputted from the AD converter 8-n and the digital difference signal after the signal processing by the radar signal processing unit 11 are denoted by the same symbol “Δ_{ele,n}.”

Furthermore, the digital difference signal outputted from the AD converter 9-n and the digital difference signal after the signal processing by the radar signal processing unit 11 are denoted by the same symbol “Δ_{azi,n}.”

The radar signal processing unit 11 outputs the digital sum signal Σₙ after the signal processing to both the multibeam generation unit 12 and the angle measurement unit 14.

The radar signal processing unit 11 outputs both the digital difference signal Δ_{ele,n} after the signal processing and the digital difference signal Δ_{azi,n} after the signal processing to the angle measurement unit 14.

The multibeam generation unit 12 is implemented by, for example, a multibeam generation circuit 22 shown in FIG. 2.

The multibeam generation unit 12 generates multiple beams including multiple DBF beams from the digital sum signals Σ₁ to Σₙ after the signal processing by the radar signal processing unit 11.

The target detection unit 13 is implemented by, for example, a target detection circuit 23 shown in FIG. 2.

The target detection unit 13 performs a process of detecting a target from the multiple beams generated by the multibeam generation unit 12, to determine the presence or absence of a target.

The angle measurement unit 14 is implemented by, for example, an angle measurement circuit 24 shown in FIG. 2.

When a determination result of the target detection unit 13 shows that there is a target, the angle measurement unit 14 performs a beamformer angle measurement on the target.

For example, the angle measurement unit 14 performs a beamformer angle measurement on the target by using the digital sum signals Σ₁ to Σₙ after the signal processing by the radar signal processing unit 11 and the digital difference signals Δ_{ele,1} to Δ_{ele,N} and Δ_{azi,1} to Δ_{azi,N} after the signal processing by the radar signal processing unit 11.

In FIG. 1, it is assumed that the radar signal processing unit 11, the multibeam generation unit 12, the target detection unit 13, and the angle measurement unit 14, which are the components of the signal processing device 10, are implemented by hardware for exclusive use as shown in FIG. 2. More specifically, it is assumed that the signal processing device 10 is implemented by the radar signal processing circuit 21, the multibeam generation circuit 22, the target detection circuit 23, and the angle measurement circuit 24.

Here, each of the following circuits: the radar signal calculating circuit 21, the multibeam generation circuit 22, the target detection circuit 23, and the angle measurement circuit 24 is, for example, a single circuit, a composite circuit, a programmable processor, a parallel programmable processor, an application specific integrated circuit (ASIC), a field-programmable gate array (FPGA), or a combination of these circuits.

The components of the signal processing device 10 are not limited to ones each implemented by hardware for exclusive use, and the signal processing device 10 may be implemented by software, firmware, or a combination of software and firmware.

The software or the firmware is stored as a program in a memory of a computer. The computer refers to hardware that executes a program, and is, for example, a central processing unit (CPU), a central processing device, a processing device, an arithmetic device, a microprocessor, a microcomputer, a processor, or a digital signal processor (DSP).

FIG. 3 is a hardware block diagram of the computer in the case in which the signal processing device 10 is implemented by software, firmware, or the like.

In the case in which the signal processing device 10 is implemented by software, firmware, or the like, a program for causing the computer to perform processing procedures of the radar signal processing unit 11, the multibeam generation unit 12, the target detection unit 13, and the angle measurement unit 14 is stored in a memory 31. A processor 32 of the computer then executes the program stored in the memory 31.

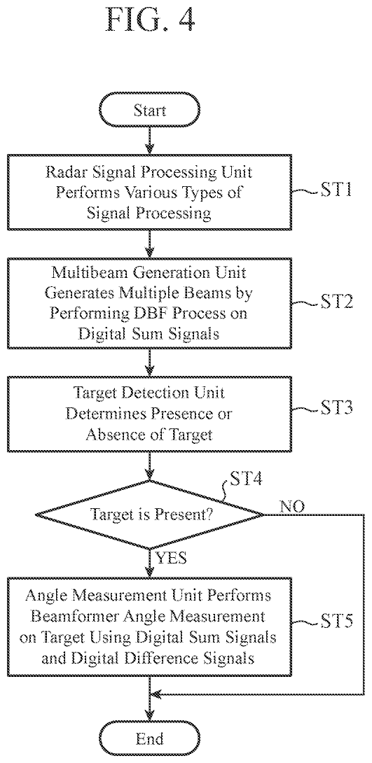

FIG. 4 is a flowchart showing a part of a target angle measurement method which is a processing procedure in the case in which the signal processing device 10 is implemented by software, firmware, or the like.

Furthermore, in FIG. 2 the example in which each of the components of the signal processing device 10 is implemented by hardware for exclusive use is shown, and in FIG. 3 the example in which the signal processing device 10 is implemented by software, firmware, or the like is shown. However, these are only examples, and some of the components in the signal processing device 10 may be implemented by hardware for exclusive use, and the remaining components may be implemented by software, firmware, or the like.

Next, the operation of the radar device shown in FIG. 1 will be explained.

Each of the subarray antennas 1-1 to 1-N arranged distributedly has multiple element antennas.

Each of the multiple element antennas that the subarray antenna 1-n (n=1, . . . , N) has receives an electric wave reflected by a target for angle measurement, and outputs a received signal of the electric wave to the RF unit 2-n.

When receiving the received signals from the multiple element antennas that the subarray antenna 1-n has, the RF unit 2-n detects each of the received signals and performs amplification and so on on each of the received signals detected.

The RF unit 2-n outputs each of the received signals which the RF unit has performed amplification and so on to the sum signal generation unit 3-n, the difference signal generation unit for elevation angle direction 5-n, and the difference signal generation unit for azimuth angle direction 6-n.

When receiving the multiple received signals from the RF unit 2-n, the sum signal generation unit 3-n generates a sum signal Σₙ by performing weighted combining of the multiple received signals in such a way that the multiple received signals are in phase with respect to the subarray beam direction.

Information showing the subarray beam direction is stored in, for example, an internal memory of the sum signal generation unit 3-n, an internal memory of the difference signal generation unit for elevation angle direction 5-n, and an internal memory of the difference signal generation unit for azimuth angle direction 6-n.

The subarray beam direction is, for example, a direction in which there is a high possibility that a target for angle measurement exists, and in which it is desired to search for a target. The subarray beam direction may be changed by, for example, an external device not illustrated.

The sum signal generation unit 3-n outputs the generated sum signal Σₙ to the AD converter 7-n.

The difference signal generation unit for elevation angle direction 5-n divides the aperture of the subarray antenna 1-n into two parts in the elevation angle direction.

Hereafter, for the sake of simplicity in explanation, one of the two parts into which the aperture is divided in the elevation angle direction is referred to as the “first aperture”, and the other one of the two parts into which the aperture is divided is referred to as the “second aperture.”

The difference signal generation unit for elevation angle direction 5-n generates a first sum signal Σ_{ele,1,n} by performing weighted combining of the received signals of the multiple element antennas corresponding to the first aperture, out of the multiple received signals outputted from the RF unit 2-n, in such a way that the received signals of the multiple element antennas corresponding to the first aperture are in phase with respect to the subarray beam direction.

Furthermore, the difference signal generation unit for elevation angle direction 5-n generates a second sum signal Σ_{ele,2,n} by performing weighted combining of the received signals of the multiple element antennas corresponding to the second aperture in such a way that the received signals of the multiple element antennas corresponding to the second aperture are in phase with respect to the subarray beam direction.

The difference signal generation unit for elevation angle direction 5-n calculates the difference between the first sum signal Σ_{ele,1,n} and the second sum signal Σ_{ele,2,n} as difference signal Δ_{ele,n}, and outputs the difference signal Δ_{ele,n} to the AD converter 8-n.

The difference signal generation unit for azimuth angle direction 6-n divides the aperture of the subarray antenna 1-n into two parts in the azimuth angle direction.

Hereafter, for the sake of simplicity in explanation, one of the two parts into which the aperture is divided in the azimuth angle direction is referred to as the “third aperture”, and the other one of the two parts into which the aperture is divided is referred to as the “fourth aperture.”

The difference signal generation unit for azimuth angle direction 6-n generates a first sum signal Σ_{azi,1,n} by performing weighted combining of the received signals of the multiple element antennas corresponding to the third aperture, out of the multiple received signals outputted from the RF unit 2-n, in such a way that the received signals of the multiple element antennas corresponding to the third aperture are in phase with respect to the subarray beam direction.

The difference signal generation unit for azimuth angle direction 6-n generates a second sum signal Σ_{azi,2,n} by performing weighted combining of the received signals of the multiple element antennas corresponding to the fourth aperture in such a way that the received signals of the multiple element antennas corresponding to the fourth aperture are in phase with respect to the subarray beam direction.

The difference signal generation unit for azimuth angle direction 6-n calculates the difference between the first sum signal Σ_{azi,1,n} and the second sum signal Σ_{azi,2,n} as difference signal Δ_{azi,n}, and outputs the difference signal Δ_{azi,n} to the AD converter 9-n.

When receiving the sum signal Σₙ from the sum signal generation unit 3-n, the AD converter 7-n converts the sum signal Σₙ from the analog signal into a digital signal.

The AD converter 7-n outputs the digital signal as a digital sum signal Σₙ to the radar signal processing unit 11.

When receiving the difference signal Δ_{ele,n} from the difference signal generation unit for elevation angle direction 5-n, the AD converter 8-n converts the difference signal Δ_{ele,n} from analog signal into digital signal.

The AD converter 8-n outputs the digital signal as digital difference signal Δ_{ele,n} to the radar signal processing unit 11.

When receiving the difference signal Δ_{azi,n} from the difference signal generation unit for azimuth angle direction 6-n, the AD converter 9-n converts the difference signal Δ_{azi,n} from analog signal into digital signal.

The AD converter 9-n outputs the digital signal as digital difference signal Δ_{azi,n} to the radar signal processing unit 11.

The radar signal processing unit 11 performs various types of signal processing on the digital sum signals Σ₁ to Σₙ, the digital difference signals Δ_{ele,1} to Δ_{ele,N}, and the digital difference signals Δ_{azi,1} to Δ_{azi,N} (step ST1 of FIG. 4).

The radar signal processing unit 11 outputs the digital sum signal Σₙ after the signal processing to both the multibeam generation unit 12 and the angle measurement unit 14.

The radar signal processing unit 11 outputs both the digital difference signal Δ_{ele,n} after the signal processing and the digital difference signal Δ_{azi,n} after the signal processing to the angle measurement unit 14.

When receiving the digital sum signal Σₙ after the signal processing from the radar signal processing unit 11, the multibeam generation unit 12 performs a DBF process on the digital sum signals Z₁ to Σₙ after the signal processing.

The multibeam generation unit 12 generates multiple beams including multiple DBF beams acquired by performing the DBF process (step ST2 of FIG. 4). Because the DBF process itself is a known technique, a detailed explanation will be omitted.

The multiple beams generated by the multibeam generation unit 12 are beams created by an antenna aperture having the same size as the entire antenna aperture (herein referred to as the “distributed aperture”) of the distributed array antenna 1.

Therefore, the multiple beams are narrower than and have a higher gain than the subarray beam of the single subarray antenna 1-n.

Because the DBF process is digital processing, the DBF beams can be generated simultaneously toward multiple directions. The multibeam generation unit 12 can improve the gain of the multiple beams by filling the inside of the multiple beams with the multiple DBF beams.

The target detection unit 13 performs the process of detecting a target from the multiple beams by performing, for example, a well-known constant false alarm rate (CFAR) process, to determine the presence or absence of a target (step ST3 of FIG. 4).

The target detection unit 13 outputs a determination result showing the presence or absence of a target to the angle measurement unit 14.

When the determination result of the target detection unit 13 shows that there is a target (when Yes in step ST4 of FIG. 4), the angle measurement unit 14 performs a beamformer angle measurement on the target (step ST5 of FIG. 4).

When the determination result of the target detection unit 13 shows that there is no target (when No in step ST4 of FIG. 4), the angle measurement unit 14 does not perform the target beamformer angle measurement to reduce the processing load.

The target beamformer angle measurement is an angle measurement using the distributed aperture.

The beamformer angle measurement by the angle measurement unit 14 is the one searching for the target and performing an angle measurement on the target within the subarray beam corresponding to each of the subarray antennas 1-1 to 1-N, by using the digital sum signals Σ₁ to Σₙ, and the digital difference signals Δ_{ele,1} to Δ_{ele,N} and Δ_{azi,1} to Δ_{azi,N}.

Hereafter, the target angle measurement process by the angle measurement unit 14 will be explained concretely.

While changing θ showing the elevation angle direction and ϕ showing the azimuth angle direction in the following equation (1), the angle measurement unit 14 searches for θ and ϕ which maximize the value of the right side.

$$\{ {\hat{θ}}_{\sum Δ BF} , {\hat{φ}}_{\sum Δ BF} \} = arg max \frac{{a}_{\sum Δ}^{H} ( θ , φ ) {\tilde{R}}_{\sum Δ \sum Δ} {a}_{\sum Δ} ( θ , φ )}{{a}_{\sum Δ}^{H} ( θ , φ ) {a}_{\sum Δ} ( θ , φ )} \qquad ( 1 )$$

In the equation (1), θ_{ΣΔBF} hat is θ at which the value of the right side is maximized, and is a search result in the elevation angle direction of the target.

ϕΔ_{BF} hat is ϕ at which the value of the right side is maximized, and is a search result in the azimuth angle direction of the target.

Because the symbol “∧” cannot be attached onto the tops of “θ” and “ϕ” in the document of the specification under the constrains on electronic applications, they are expressed like θ_{ΣΔBF} hat and ϕ_{ΣΔBF} hat.

R_{ΣΔΣΔ} tilde is a correlation matrix which has, as its elements, the complex amplitude in the range in which the target is detected and the complex amplitude in the Doppler frequency, in the digital sum signals Σ₁ to Σₙ, the digital difference signals Δ_{ele,1} to Δ_{ele,N}, and the digital difference signals Δ_{azi,1} to Δ_{azi,N}. Because the correlation matrix R_{ΣΔΣΔ} tilde itself is a well-known matrix, a detailed explanation will be omitted. The range in which the target is detected is the distance from the radar device to the target.

Because the symbol “˜” cannot be attached onto the top of “R” in the document of the specification under the constrains on electronic applications, it is expressed like R_{ΣΔΣΔ} tilde.

Because when the process of detecting a target is performed, the range in which the target is detected and the Doppler frequency are typically calculated by the target detection unit 13, the angle measurement unit 14 may acquire the range and the Doppler frequency from the target detection unit 13.

As an alternative, the angle measurement unit 14 may calculate the range and the Doppler frequency by performing the process of detecting a target.

a_{ΣΔ}(θ, ϕ) is a steering vector which has, as its elements, the theoretical relative amplitudes and relative phases of the digital sum signals Σ₁ to Σₙ, the digital difference signals Δ_{ele,1} to Δ_{ele,N}, and the digital difference signals Δ_{azi,1} to Δ_{azi,N}, with respect to the direction of (θ, ϕ).

a_{ΣΔ}(θ, ϕ) can be calculated from pieces of known information including the arrangement of the subarray antennas 1-1 to 1-N, the arrangement of the element antennas which each of the subarray antennas 1-1 to 1-N has, and the frequencies of the signals received by the subarray antennas 1-1 to 1-N.

H is a symbol showing complex conjugate transpose.

The steering vector a_{ΣΔ} is expressed by the following equation (2).

a_{ΣΔ=[}a_{Σ}^{T}, a_{Δele}^{T}, a_{Δazi}^{T}]^{T} (2)

In the equation (2), T is a symbol showing transpose.

a_{ΣΔ} is expressed by the following equation (3) , a_{Δele} is expressed by the following equation (4), and a_{Δazi} is expressed by the following equation (5).

a_{Σ}=[a_{Σ1}, a_{Σ2}, . . . a_{Σ,N}]^{T} (3)

a_{Δele}=[a_{Δele,1}, a_{Δele,2}, . . . a_{Δele,N}]^{T} (4)

a_{Δazi}=[a_{Δazi,1}, a_{Δazi,2}, . . . a_{Δazi,N}]^{T} (5)

In the equations (3) to (5), each vector on the right side corresponds to the theoretical relative amplitudes and relative phases of the digital sum signals Σ₁ to Σₙ, the digital difference signals Δ_{ele,1} to Δ_{ele,N}, or the digital difference signals Δ_{azi,1} to Δ_{azi,N}.

In the above-mentioned way, the search result θ_{ΣΔBF} hat in the elevation angle direction of the target and the search result ϕ_{ΣΔBF} hat in the azimuth angle direction of the target are acquired by the angle measurement unit 14.

Hereafter, an explanation will be made as to the principle that the degradation in the angle measuring accuracy which is caused by GLs is reduced because the digital sum signals Z₁ to Σₙ and the digital difference signals Δ_{ele,1} to Δ_{ele,N} and Δ_{azi,1} to Δ_{azi,N} are used in the target angle measurement process by the angle measurement unit 14.

In an angle measurement process on a target by using a distributed array antenna in which multiple subarray antennas are arranged, a method of improving the angle measuring accuracy by effectively using the characteristics of the distributed aperture having a large aperture is adopted.

For example, in Nonpatent Literature 2 below, an angle measurement process of performing a beamformer angle measurement on a target by using only sum signals about received signals of multiple element antennas which multiple subarray antennas have is disclosed.

[Nonpatent Literature 2] Nobuyoshi Kikuma, “Adaptive Antenna Technique”, Ohmsha, Ltd., 2003.

In Nonpatent Literature 3 below, an angle measurement process of generating each difference signal about received signals of multiple element antennas which a subarray antenna has, and performing a monopulse angle measurement in the subarray aperture which is the aperture of a subarray antenna, by using the difference signals is disclosed.

[Nonpatent Literature 3] Takashi Yoshida, “Revised Radar Technique”, Corona Publishing Co., Ltd., 1996.

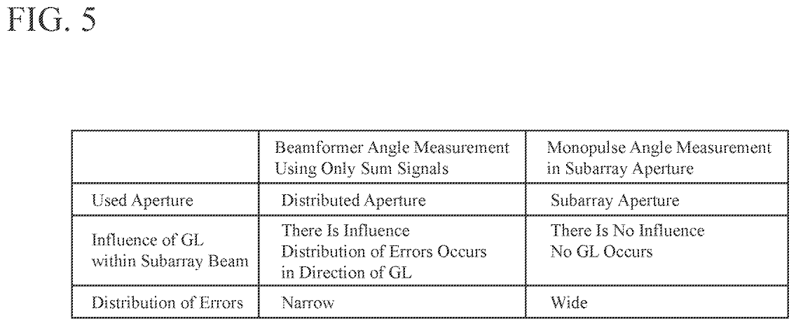

FIG. 5 is an explanatory drawing showing a result of comparison between a beamformer angle measurement using only sum signals, and a monopulse angle measurement in a subarray aperture.

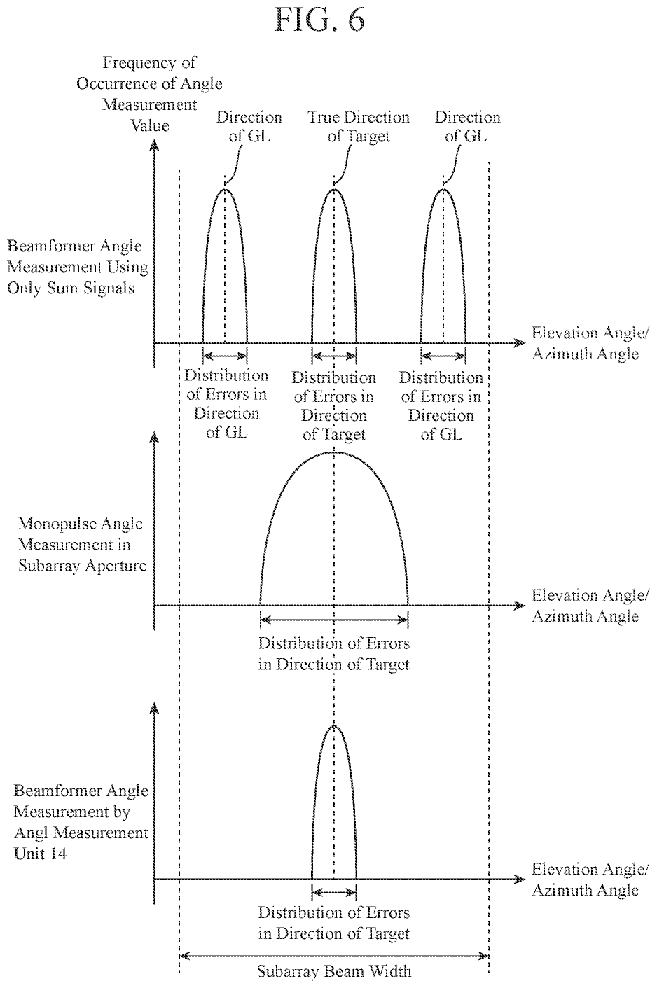

FIG. 6 is an explanatory drawing showing the distribution of errors of an angle measurement value in the beamformer angle measurement using only sum signals, the distribution of errors of an angle measurement value in the monopulse angle measurement, and the distribution of errors of an angle measurement value in the beamformer angle measurement by the angle measurement unit 14.

The beamformer angle measurement using only sum signals provides a high degree of angle measuring accuracy because the beamformer angle measurement is an angle measurement process using a large distributed aperture in principle.

However, in the case in which the number of element antennas which some of the multiple subarray antennas have is small, one or more GLs may occur in the antenna pattern. In the beamformer angle measurement using only sum signals, when a GL occurs, the direction in which the GL occurs may be detected erroneously as the direction in which a target is present.

In the beamformer angle measurement using only sum signals, the erroneous detection of the direction in which the GL occurs as the direction in which the target is present provides an angle measurement processing result showing that a distribution of errors occurs also in directions in which GLs occur, in addition to that a distribution of errors occurs in the direction of the target, as shown in FIG. 6.

The monopulse angle measurement in a subarray aperture is not an angle measurement process in the distributed aperture, but an angle measurement process in the subarray aperture. Therefore, because the search scope for the target is within a subarray beam and the monopulse angle measurement is not an angle measurement process in a large aperture, the angle measurement process is not affected by GLs.

However, because the aperture length of a subarray aperture is narrower than the aperture length of the distributed aperture, in the monopulse angle measurement in a subarray aperture, the distribution of errors in the direction of the target spreads over a wider region than the distribution of errors in the direction of the target in the beamformer angle measurement using only sum signals, as shown in FIG. 6.

As mentioned above, the beamformer angle measurement using only sum signals and the monopulse angle measurement in a subarray aperture have merits and demerits.

In the beamformer angle measurement by the angle measurement unit 14, the beamformer angle measurement is performed using both the sum signals and the difference signals in order to provide the merit of the beamformer angle measurement using only sum signals and the merit of the monopulse angle measurement in a subarray aperture.

In the beamformer angle measurement by the angle measurement unit 14, by performing a beamformer angle measurement using both the sum signals and the difference signals, the distribution of errors in the direction of the target becomes narrow and a high degree of angle measuring accuracy is provided without a distribution of errors in the direction of GL occurring, as shown in FIG. 6.

In above-mentioned Embodiment 1, the radar device is configured in such a way as to include the angle measurement unit 14 for performing a beamformer angle measurement on a target by using the sum signals generated by the multiple sum signal generation units 3-1 to 3-N and the difference signals generated by the multiple difference signal generation units 4-1 to 4-N. Therefore, the radar device can suppress the expansion of errors of the angle measurement value even when one or more GL occur in the antenna pattern.

In the radar device shown in FIG. 1, the example in which the difference signal generation unit 4-n (n=1, . . . , N) includes the difference signal generation unit for elevation angle direction 5-n and the difference signal generation unit for azimuth angle direction 6-n is shown.

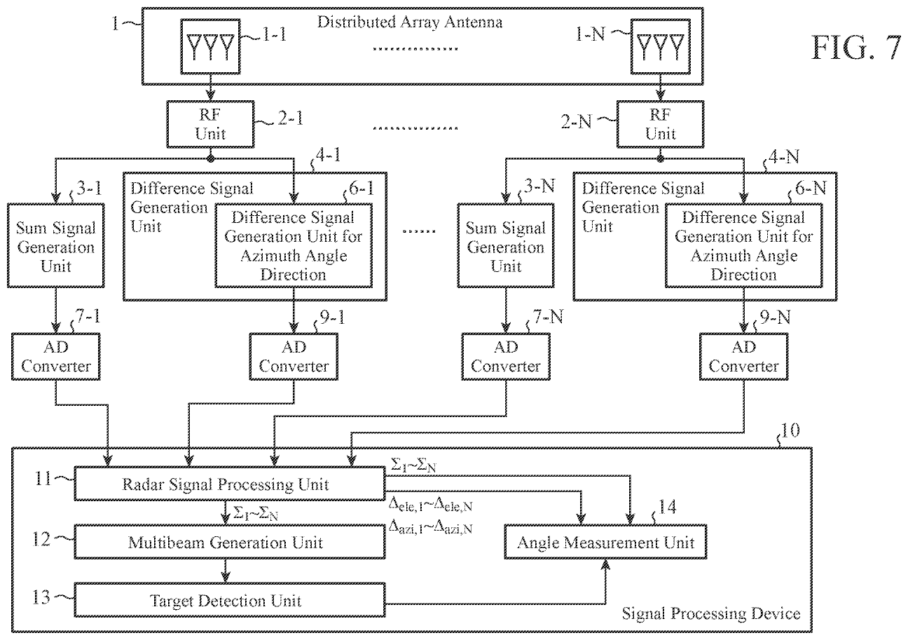

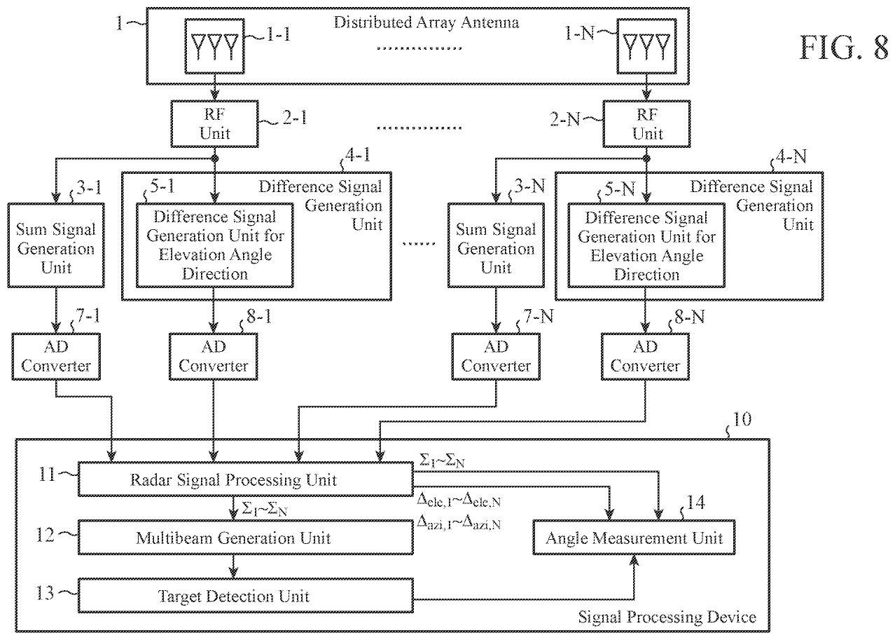

However, this is only an example, and the radar device may be one in which the difference signal generation unit 4-n includes only the difference signal generation unit for azimuth angle direction 6-n, as shown in FIG. 7. As an alternative, the radar device may be one in which the difference signal generation unit 4-n includes only the difference signal generation unit for elevation angle direction 5-n, as shown in FIG. 8.

FIGS. 7 and 8 are block diagrams showing other radar devices according to Embodiment 1.

In the case in which the difference signal generation unit 4-n includes only the difference signal generation unit for azimuth angle direction 6-n, the AD converter 8-n is unnecessary. The angle measurement unit 14 performs a beamformer angle measurement on a target by using the digital sum signals Σ₁ to Σₙ and the digital difference signals Δ_{azi,1} to Δ_{azi,n}.

In the case in which the angle measurement unit 14 uses the digital sum signals Σ₁ to Σₙ and the digital difference signals Δ_{azi,1} to Δ_{azi,n} the steering vector a_{ΣΔ}is expressed by the following equation (6).

a_{ΣΔ}=[a_{Σ}^{T}, a_{Δazi}^{T}]^{T} (6)

In the case in which the difference signal generation unit 4-n includes only the difference signal generation unit for elevation angle direction 5-n, the AD converter 9-n is unnecessary. The angle measurement unit 14 performs a beamformer angle measurement on a target by using the digital sum signals Σ₁ to Σₙ and the digital difference signals Δ_{ele,1} to Δ_{ele,n}.

In the case in which the angle measurement unit 14 uses the digital sum signals Σ₁ to Σₙ and the digital difference signals Δ_{ele,1} to Δ_{ele,N}, the steering vector a_{ΣΔ} is expressed by the following equation (7).

a_{ΣΔ}=[a_{Σ}^{T}, a_{Δele}^{T}]^{T} (7)

Even in the case in which the difference signal generation unit 4-n includes either the difference signal generation unit for azimuth angle direction 6-n or the difference signal generation unit for elevation angle direction 5-n, the expansion of errors of the angle measurement value which is caused by the occurrence of GLs can be suppressed to be less than that in the case in which the beamformer angle measurement is performed using only the digital sum signals Σ₁ to Σₙ.

In the radar device shown in FIG. 7, the difference signal generation unit 4-n includes only the difference signal generation unit for azimuth angle direction 6-n, and in the radar device shown in FIG. 8, the difference signal generation unit 4-n includes only the difference signal generation unit for elevation angle direction 5-n.

However, these are only examples, and in the multiple difference signal generation units 4-1 to 4-N, difference signal generation units each of which includes only a difference signal generation unit for azimuth angle direction and difference signal generation units each of which includes only a difference signal generation unit for elevation angle direction may be mixed.

In the radar device shown in FIG. 1, each of the subarray antennas 1-1 to 1-N has multiple element antennas.

The number of element antennas which each of the subarray antennas 1-1 to 1-N has may be equal or may differ. In the case in which the number of element antennas which each of the subarray antennas 1-1 to 1-N has differs, each element in the vectors a_{ΣΔ}, a_{Δele}, and a_{Δazi} has an amplitude value in which the difference in the number of element antennas is reflected. As the difference in the number of element antennas, the difference in the signal to noise ratio in each of the subarray antennas 1-1 to 1-N can be considered.

In the radar device shown in FIG. 1, the angle measurement unit 14 performs angle measurements both in the elevation angle direction of a target and in the azimuth angle direction of the target. However, no limitation is intended to this example, and the angle measurement unit 14 may perform an angle measurement either in the elevation angle direction of a target or in the azimuth angle direction of the target.

### Embodiment 2

The radar device shown in FIG. 1 includes the angle measurement unit 14 that performs a beamformer angle measurement on a target by using the sum signals generated by the multiple sum signal generation units 3-1 to 3-N and the difference signals generated by the multiple difference signal generation units 4-1 to 4-N.

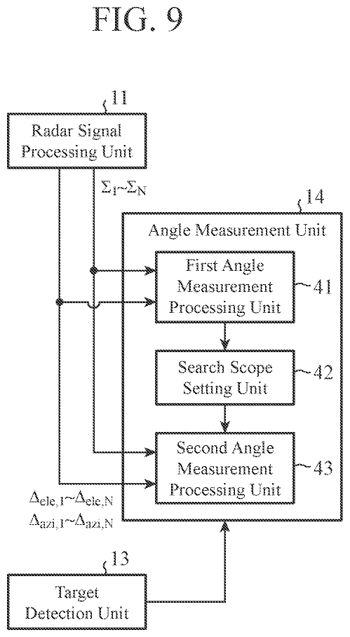

In Embodiment 2, a radar device in which an angle measurement unit 14 includes a first angle measurement processing unit 41, a search scope setting unit 42, and a second angle measurement processing unit 43, as shown in FIG. 9, will be explained.

FIG. 9 is a block diagram showing the angle measurement unit 14 of the radar device according to Embodiment 2. The configuration of components of the radar device other than the angle measurement unit 14 shown in FIG. 9 is the same as that of FIG. 1.

In FIG. 9, the first angle measurement processing unit 41 changes the direction of searching for a target in steps of a first stepsize within a subarray beam corresponding to each of multiple subarray antennas 1-1 to 1-N.

The first angle measurement processing unit 41 performs a beamformer angle measurement on a target by using digital sum signals Σ₁ to Σₙ and digital difference signals Δ_{ele,1} to Δ_{ele,N} and Δ_{azi,1} to Δ_{azi,N} while changing the target searching direction in steps of the first stepsize.

The first stepsize is substantially equal to the beam width of each DBF beam. Therefore, the search for a target while changing the target searching direction in steps of the first stepsize is a rough one, and the angle measurement process by the first angle measurement processing unit 41 is a rough one.

The search scope setting unit 42 sets up a target search scope by using an angle measurement result of the beamformer angle measurement performed by the first angle measurement processing unit 41.

As a search center in an elevation angle direction in the target search scope, the search scope setting unit 42 sets up θ_{ΣΔBF} hat in the elevation angle direction, θ_{ΣΔBF} hat being shown by the angle measurement result of the first angle measurement processing unit 41, for example. Furthermore, as a search center in an azimuth angle direction in the target search scope, the search scope setting unit 42 sets up ϕ_{ΣΔBF} hat in the azimuth angle direction, ϕ_{ΣΔBF} hat being shown by the angle measurement result of the first angle measurement processing unit 41, for example.

The search scope may be wider than the first stepsize, and is narrower than the beam width of each subarray beam.

The second angle measurement processing unit 43 changes the target searching direction in steps of a second stepsize within the search scope set up by the search scope setting unit 42.

The second angle measurement processing unit 43 performs a beamformer angle measurement on a target by using the digital sum signals Σ₁ to Σₙ and the digital difference signals Δ_{ele,1} to Δ_{ele,N} and Δ_{azi,1} to Δ_{azi,N} while changing the target searching direction in steps of the second stepsize.

The second stepsize is finer than the first stepsize.

Next, the operation of the angle measurement unit 14 shown in FIG. 9 will be explained.

Because the components other than the angle measurement unit 14 shown in FIG. 9 are the same as those of the radar device shown in FIG. 1, an explanation will be omitted hereafter.

When a determination result of the target detection unit 13 shows that there is a target, the first angle measurement processing unit 41 performs a beamformer angle measurement on the target.

The first angle measurement processing unit 41 performs a beamformer angle measurement on the target by using the digital sum signals Σ₁ to Σₙ and the digital difference signals Δ_{ele,1} to Δ_{ele,N} and Δ_{azi,1} to Δ_{azi,N} while changing the target searching direction in steps of the first stepsize within each subarray beam.

In the beamformer angle measurement in the first angle measurement processing unit 41, both 0 showing the elevation angle direction and (1) showing the azimuth angle direction are changed in steps of the first stepsize in the above-mentioned equation (1).

Because the angle measurement process by the first angle measurement processing unit 41 is a rough one, the arithmetic load is small, but the angle measurement result of the first angle measurement processing unit 41 contains a large error.

In order to provide an angle measurement value having a small error, the search scope setting unit 42 sets up a target search scope, as the target search scope used for the implementation of a fine search, by using the angle measurement result of the beamformer angle measurement performed by the first angle measurement processing unit 41.

As the search center in the elevation angle direction in the target search scope, the search scope setting unit 42 sets up θ_{ΣΔBF} hat in the elevation angle direction, θ_{ΣΔBF} hat being shown by the angle measurement result of the first angle measurement processing unit 41, for example. Further, as the search center in the azimuth angle direction in the target search scope, the search scope setting unit 42 sets up ϕ_{ΣΔBF} hat in the azimuth angle direction, ϕ_{ΣΔBF} hat being shown by the angle measurement result of the first angle measurement processing unit 41, for example.

The search scope setting unit 42 sets the width of the search scope to be wider than the first stepsize and narrower than the beam width of each subarray beam, for example.

The second angle measurement processing unit 43 performs a beamformer angle measurement on the target by using the digital sum signals Σ₁ to Σₙ and the digital difference signals Δ_{ele,1} to Δ_{ele,N} and Δ_{azi,1} to Δ_{azi,N} while changing the target searching direction in steps of the second stepsize within the search scope set up by the search scope setting unit 42.

In the beamformer angle measurement in the second angle measurement processing unit 43, both θ showing the elevation angle direction and ϕ showing the azimuth angle direction are changed in steps of the second stepsize in the above-mentioned equation (1).

Because the second stepsize is finer than the first stepsize, the error contained in an angle measurement result of the second angle measurement processing unit 43 is small.

Because the search scope set up by the search scope setting unit 42 has a width narrower than the beam width of each subarray beam, the arithmetic load is smaller than that when making a search within each subarray beam.

In above-mentioned Embodiment 2, the angle measurement unit 14 includes the first angle measurement processing unit 41 that performs a beamformer angle measurement on a target by using the sum signals and the difference signals while changing the target searching direction in steps of the first stepsize within each subarray beam.

Further, the angle measurement unit 14 includes the search scope setting unit 42 that sets up the target search scope by using the angle measurement result of the beamformer angle measurement performed by the first angle measurement processing unit 41.

In addition, the angle measurement unit 14 includes the second angle measurement processing unit 43 that performs a beamformer angle measurement on the target by using the sum signals and the difference signals while changing the target searching direction in steps of the second stepsize within the search scope set up by the search scope setting unit 42.

Therefore, the radar device of Embodiment 2 can reduce the arithmetic load to be smaller than that of the radar device of Embodiment 1. Furthermore, the radar device of Embodiment 2 can suppress the expansion of errors of the angle measurement value even when GLs occur in the antenna pattern, like that of Embodiment 1.

### Embodiment 3

In the radar device shown in FIG. 1, the multibeam generation unit 12 generates multiple beams from the digital sum signals Z₁ to Eₙ.

In Embodiment 3, an explanation will be made as to a radar device in which a multibeam generation unit 51 generates multiple beams from digital sum signals Σ₁ to Σₙ, and digital difference signals Δ_{ele,1} to Δ_{ele,N} and Δ_{azi,1} to Δ_{azi,N}.

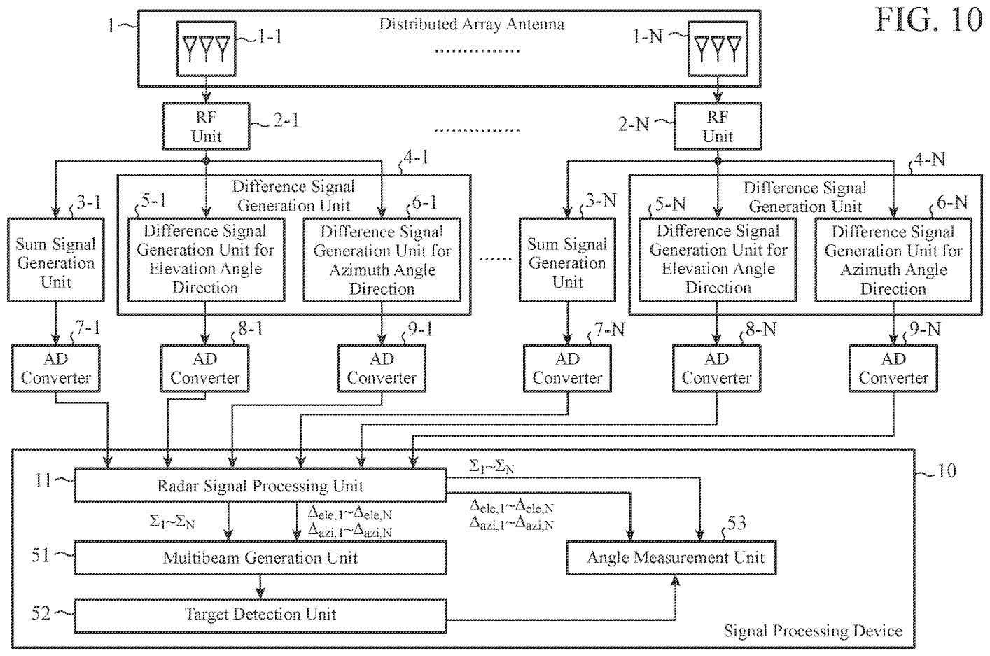

FIG. 10 is a block diagram showing the radar device according to Embodiment 3. In FIG. 10, because the same reference signs as those shown in FIG. 1 denote the same components or like components, an explanation of the components will be omitted hereafter.

The multibeam generation unit 51 is implemented by, for example, a multibeam generation circuit 22 shown in FIG. 2.

The multibeam generation unit 51 generates multiple beams including multiple DBF beams from the digital sum signals Σ₁ to Σₙ after signal processing by a radar signal processing unit 11, and the digital difference signals Δ_{ele,1} to Δ_{ele,N} and Δ_{azi,1} to Δ_{azi,N} after the signal processing by the radar signal processing unit 11.

A target detection unit 52 is implemented by, for example, the target detection circuit 23 shown in FIG. 2.

The target detection unit 52 performs a process of detecting a target from the multiple beams generated by the multibeam generation unit 51, and specifies a DBF beam in which the target is present out of the multiple DBF beams included in the multiple beams.

An angle measurement unit 53 is implemented by, for example, the angle measurement circuit 24 shown in FIG. 2.

If a target is detected by the target detection unit 52, then the angle measurement unit 53 sets the beam scope of the DBF beam specified by the target detection unit 52 as a target search scope.

The angle measurement unit 53 performs a beamformer angle measurement on the target within the set search scope, by using the digital sum signals Σ₁ to Σₙ and the digital difference signals Δ_{ele,1} to Δ_{ele,N} and Δ_{azi,1} to Δ_{azi,N} obtained after the signal processing by the radar signal processing unit 11.

Next, the operation of the radar device shown in FIG. 10 will be explained.

Note that, because the components other than the multibeam generation unit 51, the target detection unit 52, and the angle measurement unit 53 are the same as those of the radar device shown in FIG. 1, only the operations of the multibeam generation unit 51, the target detection unit 52, and the angle measurement unit 53 will be explained hereafter.

When receiving the digital sum signals Σₙ and the digital difference signals Δ_{ele,1} to Δ_{ele,N} and Δ_{azi,1} to Δ_{azi,N} after the signal processing from the radar signal processing unit 11, the multibeam generation unit 51 performs a DBF process on the digital sum signals Σₙ and the digital difference signals Δ_{ele,1} to Δ_{ele,N} and Δ_{azi,1} to Δ_{azi,N}.

The multibeam generation unit 51 generates multiple beams including multiple DBF beams which are acquired by performing the DBF process.

Although a detailed explanation will be omitted because the DBF process itself is a known technique, GLs can be prevented from occurring in the antenna pattern because the multibeam generation unit 51 uses not only the digital sum signals Σₙ but also the digital difference signals Δ_{ele,1} to Δ_{ele,N} and Δ_{azi,1} to Δ_{azi,N}.

The target detection unit 52 detects a target from the multiple beams by performing, for example, a well-known CFAR process.

When detecting a target, the target detection unit 52 specifies the DBF beam in which the target is present, out of the multiple DBF beams included in the multiple beams, and outputs both the elevation angle direction and the azimuth angle direction of the specified DBF beam to the angle measurement unit 53.

Because the occurrence of GLs is suppressed by the multibeam generation unit 51, the detecting accuracy of a target in the target detection unit 52 is higher than the detecting accuracy of a target in the target detection unit 13 shown in FIG. 1.

If a target is detected by the target detection unit 52, then the angle measurement unit 53 sets the beam scope of the DBF beam specified by the target detection unit 52 as the target search scope.

The angle measurement unit 53 performs a beamformer angle measurement on the target within the set search scope by using the digital sum signals Σ₁ to Σₙ and the digital difference signals Δ_{ele,1} to Δ_{ele,N} and Δ_{azi,1} to Δ_{azi,N} obtained after the signal processing by the radar signal processing unit 11.

In the beamformer angle measurement by the angle measurement unit 53, both θ showing the elevation angle direction and ϕ showing the azimuth angle direction are changed, in the above-mentioned equation (1), in steps of, for example, the above-mentioned second stepsize.

Because the search scope set up by the angle measurement unit 53 has a width narrower than the beam width of each subarray beam, the arithmetic load is smaller than that when making a search within each subarray beam.

In above-mentioned Embodiment 3, the multibeam generation unit 51 that generates multiple beams including multiple DBF beams from the sum signals and the difference signals is included.

Furthermore, the target detection unit 52 that performs the process of detecting a target from the multiple beams generated by the multibeam generation unit 51 and specifies the DBF beam in which the target is present out of the multiple DBF beams included in the multiple beams is included.

In addition, the angle measurement unit 53 that sets the beam scope of the DBF beam specified by the target detection unit 52 as the target search scope, and performs a beamformer angle measurement on the target within the set search scope by using the sum signals and the difference signals is included.

Therefore, the radar device of Embodiment 3 can suppress the expansion of errors of an angle measurement value even when GLs occur in the antenna pattern.

### Embodiment 4

According to the radar device shown in FIG. 1, the angle measurement unit 14 performs a beamformer angle measurement on a target.

In Embodiment 4, a radar device in which an angle measurement unit 61 performs a monopulse angle measurement instead of performing a beamformer angle measurement on a target will be explained.

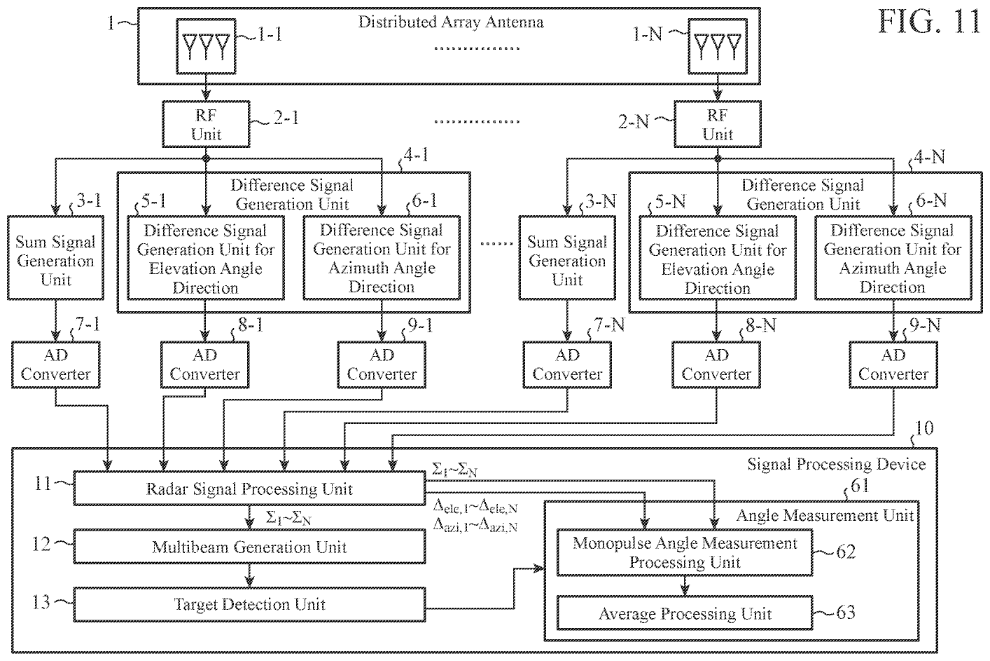

FIG. 11 is a block diagram showing the radar device according to Embodiment 4. In FIG. 11, because the same reference signs as those shown in FIG. 1 denote the same components or like components, an explanation of the components will be omitted hereafter.

The angle measurement unit 61 is implemented by, for example, the angle measurement circuit 24 shown in FIG. 2, and includes a monopulse angle measurement processing unit 62 and an average processing unit 63.

The angle measurement unit 61 performs a monopulse angle measurement on a target within the subarray beam corresponding to each of multiple subarray antennas 1-1 to 1-N, by using digital sum signals Σ₁ to Σₙ and digital difference signals Δ_{ele,1} to Δ_{ele,N} and Δ_{azi,1} to Δ_{azi,N} obtained after signal processing by a radar signal processing unit 11.

The angle measurement unit 61 performs weighted averaging on angle measurement results of the monopulse angle measurement within each subarray beam.

The monopulse angle measurement processing unit 62 performs a monopulse angle measurement on the target within each subarray beam by using the digital sum signals Z₁ to Σₙ and the digital difference signals Δ_{ele,1} to Δ_{ele,N} and Δ_{azi,1} to Δ_{azi,N} obtained after the signal processing by the radar signal processing unit 11.

The average processing unit 63 performs the weighted averaging on the angle measurement results of the monopulse angle measurement within each subarray beam, the angle measurement results being provided by the monopulse angle measurement processing unit 62.

Next, the operation of the radar device shown in FIG. 11 will be explained.

However, because the components other than the angle measurement unit 61 is the same as those of the radar device shown in FIG. 1, only the operation of the angle measurement unit 61 will be explained hereafter.

If a determination result of the target detection unit shows that a target is present, the monopulse angle measurement processing unit 62 performs a monopulse angle measurement on the target within each subarray beam.

The monopulse angle measurement on the target is an angle measurement using the subarray aperture.

The monopulse angle measurement by the monopulse angle measurement processing unit 62 is the one in which the target is searched for and an angle measurement is performed on the target by using the digital sum signals Σ₁ to Σₙ and the digital difference signals Δ_{ele,1} to Δ_{ele,N} and Δ_{azi,1} to Δ_{azi,N} obtained after the signal processing by the radar signal processing unit 11.

Because the monopulse angle measurement itself is a known technique, a detailed explanation will be omitted. The monopulse angle measurement has the merit of being not affected by GLs but has the demerit of providing a wide distribution of errors in the direction of the target.

The average processing unit 63 performs the weighted averaging on angle measurement results of the monopulse angle measurement within each subarray beam, the angle measurement results being provided by the monopulse angle measurement processing unit 62.

Specifically, the average processing unit 63 performs the weighted averaging on an angle measurement result in an elevation angle direction within each subarray beam.

Furthermore, the average processing unit 63 performs the weighted averaging on an angle measurement result in an azimuth angle direction within each subarray beam.

The average processing unit 63 can narrow the distribution of errors in the target direction by performing the weighted averaging on the angle measurement results of the monopulse angle measurement within each subarray beam.

In above-mentioned Embodiment 4, the angle measurement unit 61 performs a monopulse angle measurement on a target, instead of performing a beamformer angle measurement on the target, within each subarray beam by using the sum signals and the difference signals. Furthermore, the radar device is configured in such a way that the angle measurement unit 61 performs the weighted averaging on angle measurement results of the monopulse angle measurement within each subarray beam. Therefore, the radar device of Embodiment 4 can suppress the expansion of errors of an angle measurement value even when GL occurs in the antenna pattern.

### Embodiment 5

In Embodiment 5, an angle measurement unit 61 sets up a target search scope by using an angle measurement result on which weighted averaging is performed. An explanation will be made as to a radar device in which the angle measurement unit 61 then performs a beamformer angle measurement on a target within the set-up search scope by using digital sum signals Σ₁ to Σₙ after signal processing by a radar signal processing unit 11.

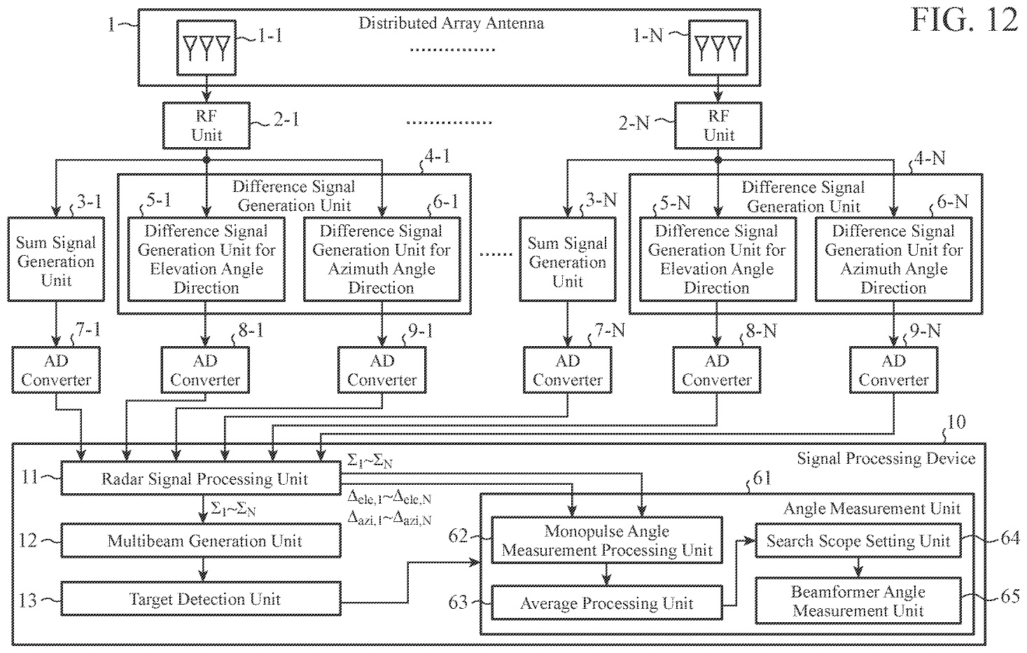

FIG. 12 is a block diagram showing the radar device according to Embodiment 5. In FIG. 12, because the same reference signs as those shown in FIGS. 1 and 11 denote the same components or like components, an explanation of the components will be omitted hereafter.

A search scope setting unit 64 sets up a target search scope by using the angle measurement result on which the weighted averaging is performed by an average processing unit 63.

A beamformer angle measurement unit 65 performs a beamformer angle measurement on a target within the search scope set up by the search scope setting unit 64 by using the digital sum signals Σ₁ to Σₙ after the signal processing by the radar signal processing unit 11.

Next, the operation of the radar device shown in FIG. 12 will be explained.

However, because the components other than the search scope setting unit 64 and the beamformer angle measurement unit 65 are the same as those of the radar device shown in FIG. 11, only the operations of the search scope setting unit 64 and the beamformer angle measurement unit 65 will be explained hereafter.

When receiving the angle measurement result after the weighted averaging from the average processing unit 63, the search scope setting unit 64 specifies the DBF beam containing an elevation angle direction and an azimuth angle direction which are shown by the angle measurement result after the weighted averaging, out of multiple DBF beams included in multiple beams.

The search scope setting unit 64 sets the beam scope of the specified DBF beam as the target search scope.

The beamformer angle measurement unit 65 performs a beamformer angle measurement on a target within the search scope set up by the search scope setting unit 64 by using the digital sum signals Σ₁ to Σₙ after the signal processing by the radar signal processing unit 11.

Specifically, while changing both θ showing the elevation angle direction and ϕ showing the azimuth angle direction in the following equation (8) within the search scope set up by the search scope setting unit 64, the beamformer angle measurement unit 65 searches for θ and ϕ which maximize the value of the right side.

$$\{ {\hat{θ}}_{\sum BF} , {\hat{φ}}_{\sum BF} \} = arg max \frac{{a}_{\sum }^{H} ( θ , φ ) {\tilde{R}}_{\sum \sum } {a}_{\sum } ( θ , φ )}{{a}_{\sum }^{H} ( θ , φ ) {a}_{\sum } ( θ , φ )} \qquad ( 8 )$$

In the equation (8), θ_{ΣBF} hat is θ at which the value of the right side is maximized, and is a search result in the elevation angle direction of the target.

ϕ_{ΣBF} hat is ϕ at which the value of the right side is maximized, and is a search result in the azimuth angle direction of the target.

R_{ΣΣ} tilde is a correlation matrix which has, as its elements, the complex amplitude in the range in which the target is detected and the complex amplitude in the Doppler frequency, in the digital sum signals Σ₁ to Σₙ. Because the correlation matrix R_{ΣΣ} tilde itself is a well-known matrix, a detailed explanation will be omitted.

a_{Σ}(θ, ϕ) is a steering vector which has, as its elements, the theoretical relative amplitudes and relative phases of the digital sum signals Σ₁ to Σₙ with respect to the direction of (θ, ϕ).

a_{Σ}(θ, ϕ) can be calculated from pieces of known information including the arrangement of subarray antennas 1-1 to 1-N, the arrangement of the element antennas which each of the subarray antennas 1-1 to 1-N has, and the frequencies of the signals received by the subarray antennas 1-1 to 1-N.

The steering vector a_{Σ} is expressed by the following equation (9).

a_{Σ}=[a_{Σ,1}, a_{Σ,2}, . . . a_{Σ,N}]^{T} (9)

In the equation (9), each vector on the right side corresponds to the theoretical relative amplitudes and relative phases of the digital sum signals Σ₁ to Σₙ.

In above-mentioned Embodiment 5, the radar device is configured in such a manner that the angle measurement unit 61 sets up the target search scope by using the angle measurement result on which the weighted averaging is performed, and performs a beamformer angle measurement on a target within the set-up search scope by using the sum signals. Therefore, the radar device of Embodiment 5 can improve the angle measuring accuracy compared with the radar device of Embodiment 4.

It is to be understood that any combination of two or more of the embodiments can be made, various modifications can be made to any components according to the embodiments, or any components according to the embodiments can be omitted within the scope of the present disclosure.

### INDUSTRIAL APPLICABILITY

The present disclosure is suitable for a radar device for and a target angle measurement method of performing an angle measurement on a target.

### REFERENCE SIGNS LIST

1 distributed array antenna, 1-1 to 1-N subarray antenna, 2-1 to 2-N RF unit, 3-1 to 3-N sum signal generation unit, 4-1 to 4-N difference signal generation unit, 5-1 to 5-N difference signal generation unit for elevation angle direction, 6-1 to 6-N difference signal generation unit for azimuth angle direction, 7-1 to 7-N AD converter, 8-1 to 8-N AD converter, 9-1 to 9-N AD converter, 10 signal processing device, 11 radar signal processing unit, 12 multibeam generation unit, 13 target detection unit, 14 angle measurement unit, 21 radar signal processing circuit, 22 multibeam generation circuit, 23 target detection circuit, 24 angle measurement circuit, 31 memory, 32 processor, 41 first angle measurement processing unit, 42 search scope setting unit, 43 second angle measurement processing unit, 51 multibeam generation unit, 52 target detection unit, 53 angle measurement unit, 61 angle measurement unit, 62 monopulse angle measurement processing unit, 63 average processing unit, 64 search scope setting unit, and 65 beamformer angle measurement unit.

1. A radar device comprising:
multiple subarray antennas each having multiple element antennas;
multiple sum signal generators respectively connected to the multiple subarray antennas, for each generating a sum signal of signals of the multiple element antennas which each of the subarray antennas has;
multiple difference signal generators respectively connected to the multiple subarray antennas, for each generating a difference signal of the signals of the multiple element antennas which each of the subarray antennas has; and
processing circuitry to perform a beamformer angle measurement on a target by searching for one or more angles of the target using the sum signals generated by the multiple sum signal generators and the difference signals generated by the multiple difference signal generators.

2. The radar device according to claim 1, wherein the processing circuitry is further configured to
generate multiple beams from the sum signals generated by the multiple sum signal generators; and
perform a process of detecting a target from the multiple beams to determine presence or absence of a target,
wherein the processing circuitry performs a beamformer angle measurement on a target if a result of the determination shows that the target is present.

3. The radar device according to claim 1, wherein
the multiple sum signal generators generate the sum signals by combining the signals of the multiple element antennas in such a way that the signals of the multiple element antennas which each of the subarray antennas has are in phase in a subarray beam direction, and
the multiple difference signal generators each generate a first sum signal by dividing an aperture of each of the subarray antennas into two parts, and combining signals of multiple element antennas for one of the two parts into which the aperture is divided, out of the multiple element antennas which each of the subarray antennas has, in such a way that the signals of the multiple element antennas for the one of the two parts into which the aperture is divided are in phase in the subarray beam direction and also generate a second sum signal by combining signals of multiple element antennas for another one of the two parts into which the aperture is divided, out of the multiple element antennas which each of the subarray antennas has, in such a way that the signals of the multiple element antennas for the other one of the two parts into which the aperture is divided are in phase in the subarray beam direction, and calculate a difference between the first sum signal and the second sum signal as the difference signal.

4. The radar device according to claim 3, wherein the multiple difference signal generators each include at least one of:
a difference signal generator for elevation angle direction for, when generating each of the first and second sum signals, generating a difference signal in an elevation angle direction by dividing the aperture of each of the subarray antennas into two parts in the elevation angle direction, and
a difference signal generator for azimuth angle direction for, when generating each of the first and second sum signals, generating a difference signal in an azimuth angle direction by dividing the aperture of each of the subarray antennas into two parts in the azimuth angle direction, and
output at least one of the difference signal in the elevation angle direction and the difference signal in the azimuth angle direction to the processing circuitry.

5. The radar device according to claim 1, wherein the processing circuitry, as the beamformer angle measurement on the target, searches for the target within a subarray beam corresponding to each of the multiple subarray antennas and performs an angle measurement on the target, by using the sum signals generated by the multiple sum signal generators and the difference signals generated by the multiple difference signal generators.

6. The radar device according to claim 1, wherein the processing circuitry is further configured to:
perform a first beamformer angle measurement on the target by using the sum signals generated by the multiple sum signal generators and the difference signals generated by the multiple difference signal generators, while changing a direction of searching for the target in steps of a first stepsize within a subarray beam corresponding to each of the multiple subarray antennas;
set up a search scope for the target by using a result of the first beamformer angle measurement; and
perform a second beamformer angle measurement on the target by using the sum signals generated by the multiple sum signal generators and the difference signals generated by the multiple difference signal generators, while changing the target searching direction in steps of a second stepsize finer than the first stepsize within the set-up search scope.

7. The radar device according to claim 1, wherein the processing circuitry is further configured to:
generate multiple beams including multiple digital beam forming (DBF) beams from the sum signals generated by the multiple sum signal generators and the difference signals generated by the multiple difference signal generators; and
perform a process of detecting a target from the generated multiple beams, and specify a DBF beam in which a detected target is present out of the multiple DBF beams,
and wherein the processing circuitry sets a beam range of the specified DBF beam as a search scope for targets, and perform a beamformer angle measurement on the target within the search scope, by using the sum signals generated by the multiple sum signal generators and the difference signals generated by the multiple difference signal generators.

8. The radar device according to claim 1, wherein the processing circuitry is further configured to perform a monopulse angle measurement on the target, instead of performing a beamformer angle measurement on the target, within a subarray beam corresponding to each of the multiple subarray antennas, by using the sum signals generated by the multiple sum signal generators and the difference signals generated by the multiple difference signal generators, and perform weighted averaging on a measurement result of the monopulse angle measurement within the subarray beam corresponding to each of the multiple subarray antennas.

9. The radar device according to claim 8, wherein the processing circuitry is further configured to set up a search scope for the target by using an angle measurement result on which the weighted averaging is performed, and perform a beamformer angle measurement on the target within the search scope by using the sum signals generated by the multiple sum signal generators.

10. The radar device according to claim 1, wherein the multiple subarray antennas are arranged at unequal intervals.

11. The radar device according to claim 1, wherein the processing circuitry is further configured to perform an angle measurement in either an elevation angle direction of the target or an azimuth angle direction of the target.

12. The radar device according to claim 1, wherein the processing circuitry is further configured to perform an angle measurement in both an elevation angle direction of the target and an azimuth angle direction of the target.

13. A target angle measurement method comprising:
generating, by multiple sum signal generators respectively connected to multiple subarray antennas having multiple element antennas, a sum signal of signals of the multiple element antennas which each of the subarray antennas has;
generating, by multiple difference signal generators respectively connected to the multiple subarray antennas, a difference signal of the signals of the multiple element antennas which each of the subarray antennas has; and
performing, by processing circuitry, a beamformer angle measurement on a target by searching for one or more angles of the target using the sum signals generated by the multiple sum signal generators and the difference signals generated by the multiple difference signal generators.
